(19) United States
(12) Patent Application Publication
(10) Pub. No.: US 2010/0038825 A1
(43) Pub. Date: Feb. 18, 2010

(54) METHODS OF FORMING MICROCHANNELS BY ULTRAFAST PULSED LASER DIRECT-WRITE PROCESSING

(76) Inventors: Joel P. McDonald, Albuquerque, NM (US); Steven M. Yalisove, Ann Arbor, MI (US); Gerard Mourou, Paris (FR)

Correspondence Address: HARNESS, DICKEY & PIERCE, P.L.C., P.O. BOX 828, BLOOMFIELD HILLS, MI, 48303, US

(21) Appl. No.: 11/963,573

(22) Filed: Dec. 21, 2007

Related U.S. Application Data
(60) Provisional application No. 60/876,590, filed on Dec. 21, 2006.

(51) Int. Cl. B29C 35/08

(52) U.S. Cl. 264/400

(57) ABSTRACT

Microscale and/or nanoscale structural features are formed in material by using an ultrashort pulsed laser (e.g., a femtosecond pulsed laser). Methods of forming such structures comprise applying laser energy generated by an ultrashort pulsed laser to a surface of a substrate having a first layer and a distinct second layer. The first layer has a first ablation threshold that is less than the applied laser energy and the second layer has a second ablation threshold that is greater than the applied laser energy. The laser energy penetrates through the second layer to the first layer. The applied laser energy results in damage (or an ablation event) at the first layer that exerts force sufficient to delaminate the second layer, thereby forming a void space that is a channel having a major elongate axis or alternately forming an open groove.

### CROSS-REFERENCE TO RELATED APPLICATIONS

This application claims the benefit of U.S. Provisional Application No. 60/876,590, filed on Dec. 21, 2006. The disclosure of the above application is incorporated herein by reference.

### GOVERNMENT RIGHTS

This invention was made with government support under Grant No. DMR-0307040 awarded by the National Science Foundation and under Defense Advance Research Projects Agency (DARPA)/Air Force Office of Sponsored Research (AFOSR) Grant No. FA9550-04-0136. The government has rights in the invention.

### FIELD

The present disclosure relates to methods of selective removal and/or delamination by ultrashort pulsed laser processing of transparent layers to create microscale and/or nanoscale structures.

### BACKGROUND

The statements in this section merely provide background information related to the present disclosure and may not constitute prior art. In the field of nanotechnology, it is desirable to create well-defined features having high resolution with feature sizes that are smaller than the wavelength of visible light. However, it has continued to be a challenge to find processes capable of forming such features while inflicting minimal damage, requiring minimal processing steps, complexity, and duration, while having high reproducibility and repeatability. Additionally, it is desirable that such processes also have relatively low processing costs for industrial and commercial practicability. Thus, it is desirable to be able to form high resolution, reproducible, low-damage micro and nano-scale features at a relatively low cost.

### SUMMARY

In various aspects, the present disclosure provides methods of forming a microscale feature on a surface of a substrate by using an ultrashort pulsed laser. In various aspects, a method of forming a channel on a substrate is provided. By way of example, a method is provided for forming a microscale channel on a surface of a microfluidic device. The method comprises applying laser energy generated by an ultrashort pulsed laser to a region of the surface of the substrate. The substrate comprises a first layer which is in contact with a distinct second layer. The first layer has a first ablation threshold that is less than the applied laser energy and the second layer has a second ablation threshold that is greater than the applied laser energy. In certain aspects, the second layer is largely transparent to the incident laser light. Thus, the laser energy penetrates through the second layer to the first layer where it is applied to the substrate. A void space is generated between the first layer and the second layer, thereby forming a channel having a major elongate axis. The channel is thus capable of transferring, receiving and/or storing fluids.

In other aspects, a method of forming an electrochemical cell is provided, where a substrate is provided that comprises at least two layers. At least one of the layers is an active material for the electrochemical cell. Laser energy as generated by an ultrashort pulsed laser, is applied to the surface of the substrate. At least one of the two layers has a first ablation threshold that is less than the applied laser energy and another of the at least two layers has a second ablation threshold that is greater than the applied laser energy. The laser energy penetrates through the layer having the second ablation threshold to the layer having the first ablation threshold. In this manner, at least void space is generated between the at least two layers to form a channel having a major elongate axis, which is capable of containing a second active material. This method thus provides the ability to generate a three-dimensional electrochemical device, such as a battery.

In yet another method, a cooling channel is formed on a surface of a device. The method comprises applying laser energy generated by an ultrashort pulsed laser to a region of the surface of a microelectronic device. The region of the substrate comprises a first layer which is in contact, by way of example, by chemical bonding or other adherence, with a distinct second layer. The first layer has a first ablation threshold that is less than the applied laser energy and the second layer has a second ablation threshold that is greater than the applied laser energy. The laser energy penetrates through the second layer to the first layer; and generates a void space between the first and second layers to form a fluid channel having a major elongate axis capable of receiving a heat transfer medium, such as a coolant, that cools the device.

In yet other aspects, the present disclosure provides a method of forming a microelectronic device which comprises applying laser energy generated by an ultrashort pulsed laser to a region of the surface of a microelectronic device. The region of the substrate comprises a first layer which is in contact with, by way of example, by chemical bonding or other adherence, a distinct second layer, where the first layer has a first ablation threshold that is less than the applied laser energy and the second layer has a second ablation threshold that is greater than the applied laser energy. The laser energy penetrates through the second layer to the first layer and generates a void space between the first layer and the second layer, thereby forming a channel having a major elongate axis capable of receiving and/or storing a solid and/or fluid material.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is an exemplary schematic of a setup for an ultrashort pulsed laser used for a linear channel writing technique in accordance with the present disclosure;

FIG. 2 is a schematic of linear writing technique in accordance with the present disclosure using an ultrashort pulsed laser to form a channel via a single track pattern or a multiple track pattern on the substrate;

FIGS. 3A-3C show examples of direct written fluidic channels formed by an ultrashort pulsed laser (a femtosecond laser) at a laser fluence of 0.35 J/cm², where FIG. 3A shows an optical microscopy of the channels; FIG. 3B shows an atomic force microscopy (AFM) section analysis of a channel produced with a single pass at a write speed of 1 cm/s, and FIG. 3C shows an AFM section analysis of a channel produced with seven passes overlapped laterally with a spacing of 15 μm exhibiting the so-called telephone-cord mode;

FIGS. 4A-4C shows examples of channel variations produced with an ultrafast laser direct write technique in accordance with certain principles of the present disclosure, where FIG. 4A shows an OM image of a Nomarski mode of grid network formed by bitwise laser writing produced in a 1200 nm thermal oxide on Si(100); FIG. 4B shows an AFM topographic image of the intersection of two channels and FIG. 4C shows an AFM topographic image of a series of channel corners;

FIG. 5 is a plot showing a linear fit of the measured channel height as a function of its width, restricted to Euler-type channel modes;

FIGS. 6A-6C show examples of surface roughness of a channel interior prepared in accordance with certain aspects of the present disclosure, where FIG. 6A is an AFM section analysis of bottom surface of a popped channel indicating a peak roughness of about 409 nm and a root mean square (rms) roughness of 59 nm; FIG. 6B is an SEM image at a tilt of 59° on the end of a channel written off the edge of a sample; and FIG. 6C shows an SEM image of laser induced roughness of the substrate;

FIG. 7 is a chart showing measurement of electrophoretic flow velocity as a function of applied electric field of 20 nm carboxolate modified polystyrene spheres through a channel having a width of about 220 μm and a maximum height of about 10 μm height;

FIG. 8A shows a perspective view of an electrophoretic device comprising a microfluidic device in a polydimethylsiloxane mold for fluid delivery;

FIG. 8B shows a sectional view of the electrophoretic device in FIG. 8A;

FIGS. 9A and 9B show general schematics of material system structure suitable for use with the present teachings to produce channels or voids between at least two layers;

FIG. 10 shows multiple-stages in a process for forming a three-dimensional microdevice structure, such as an electrochemical device; and

FIG. 11 is an exemplary schematic of a setup for an ultrashort pulsed laser used for parallel and simultaneous channel writing technique in accordance with the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. It should be understood that the description and specific examples are intended for purposes of illustration only and are not intended to limit the scope of the present disclosure.

In various aspects, the disclosure provides methods of forming structures or features that are on a microscale. In some aspects, the structure is optionally smaller than a microstructure, such as a nanoscale structure. As used herein, “microscale” refers to a structure having at least one dimension that is less than about 100 μm, optionally less than about 10 μm and in some aspects, less than about 1 μm. A “nanoscale” structure has at least one dimension that is less than about 100 nm (0.1 μm), optionally less than about 50 nm, and optionally less than about 10 nm. As used herein, reference to a microscale, microstructure, micro-channel, or microfluidic channels, encompasses smaller structures, such as the equivalent nanoscale structures, as well. In other aspects, the channels formed in materials according to the present teachings are optionally formed on a macroscale, for example, having at least one dimension having an exemplary length on the order of about 1 cm, optionally about 1 mm, optionally about 0.5 mm (500 μm), and in some aspects, about 0.25 mm (250 μm).

Thus, in certain aspects, methods are provided for forming a microscale structure (optionally any structure that is a microstructure or smaller) within or on a surface of a substrate, where the microscale structure has a major elongate axis. A major elongate axis refers to a shape having a prominent elongate dimension. For example, a major elongate axis often refers to cylindrical or axial geometry having an aspect ratio defined as AR=L/D where L is the length of the longest axis and D is the diameter of the shape. Generally, desirable shapes embodying a major elongate axis have large aspect ratios, for example greater than about 500 and optionally greater than 5,000 or more. Thus, a structure having a major elongate axis generally has dimensions such that the length of the structure forms the greatest dimension, for example, a groove (an open shape) or channel (a structurally closed geometry).

In certain aspects, a substrate comprises a first layer (e.g., a substrate) having a first surface and a second layer (e.g., a film) having a second surface, where the first and second surfaces are in contact with one another (e.g., the first layer and the second layer are chemically bonded or otherwise adhered to each other). A void is formed between the first and second layers when a portion of the second layer (e.g., the film) is separated (e.g., delaminated) and forced away from the first surface of the first layer (e.g., the substrate). In certain aspects the inflicted damage (e.g., ablation and/or modification) is limited and localized (for example, limited to a depth within 100 nm of the interfacial surface between the first and second layers).

The method comprises applying laser energy to a surface of the substrate, where the laser energy is generated by an ultrafast laser that generates ultrashort laser pulses. In certain aspects, the ultrafast laser is a femtosecond pulsed laser. By “ultrashort” pulsed laser, it is meant that the temporal width of pulses (i.e., the pulse duration of the laser energy applied, which is optionally a variable pulse duration) is less than about 100 picosecond (ps) or 100,000 femtosecond (fs) (a femtosecond (fs) is 10⁻¹⁵ seconds), optionally less than about 1 picosecond (ps) or 1000 femtosecond (fs), at a pulse repetition rate of greater than about 10 Hz. For example, chirped-pulse amplification fs lasers are particularly suitable, having stable pulse energies and significant peak powers (10¹² watts) capable of producing optical breakdown and material removal in various materials, such as dielectrics, semiconductors, and metals. In certain aspects, the ultrafast pulsed laser has a pulse duration that is less than about 600 fs, optionally less than about 150 fs, with a repetition rate of greater than about 125 Hz, optionally greater than or equal to about 1 kHz.

While such ultrafast lasers include femtosecond pulsed lasers, they are not limited solely to lasers producing a laser pulse with a 1 to 999 femtosecond duration, but may include slightly longer (picosecond (on the order of 10⁻¹² seconds)) or slightly shorter (attosecond (on the order of 10⁻¹⁸ seconds)) pulsed lasers, including those known or to be developed in the art. Such ultrafast fs pulsed lasers provide significantly different ablation results than lasers which provide nanosecond (ns) laser ablation of materials. “Ablation” as used herein is the removal of material from the surface of sample, which can be physically observed, such as by optical microscopy (OM), scanning electron microscopy (SEM), or atomic force microscopy (AFM) techniques, for example. In preferred aspects, the ablation is produced by an ultrafast laser-induced ablation. Material ablation thresholds (F_{Th}) behave in a significantly different manner with ultrafast laser pulses (for pulse widths below 10 ps) than for conventional nanosecond lasers.

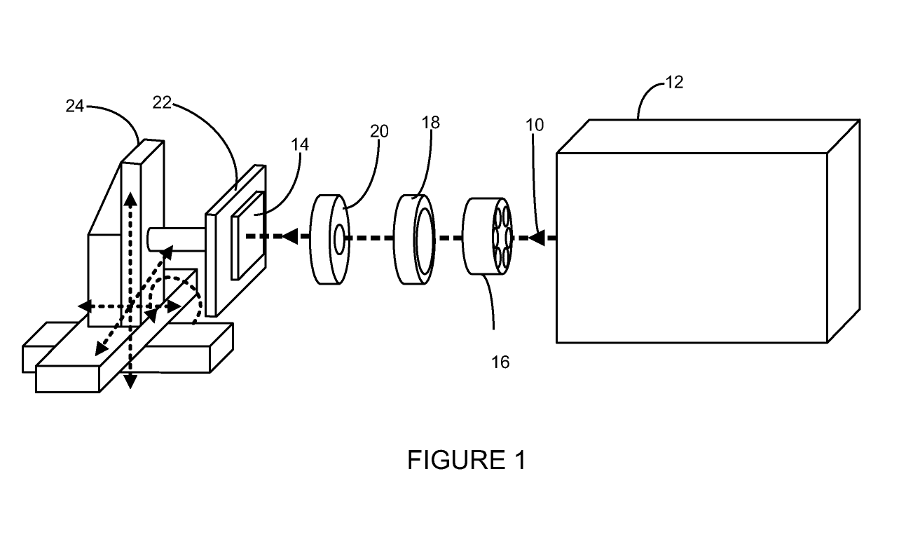

In certain aspects, a suitable laser pulse has a central wavelength of less than about 800 nm, and an energy level of about 800 μJ. In some aspects, a suitable ultrafast laser has a pulse repetition rate frequency of greater than or equal to about 125 Hz, and a pulse duration of less than or equal to about 600 femtoseconds. In certain aspects, the ultrafast laser generates a fluence of the applied laser energy that is less than about 0.8 J/cm². In one exemplary and non-limiting example, a suitable ultrafast laser is commercially available as a CPA 2001 sold by Clark-MXR, Inc. of Dexter, Mich., U.S.A., a titanium:sapphire laser that generates pulsed laser energy having a temporal width of about 150 fs at a pulse repetition rate of about 1 kHz. Each laser pulse has a central wavelength of about 775 nm and a maximum energy of about 800 μJ. The laser beam has a Gaussian spatial beam intensity profile. FIG. 1 displays an exemplary optics setup used to deliver a suitable laser beam to a substrate, as will be described in more detail below.

Thus, in various aspects, the methods of the invention comprise applying a laser energy generated by an ultrashort pulsed laser to a surface of the sample, where the sample comprises a first layer (e.g., a substrate) and a distinct second layer (e.g., a thin film). As used herein, each so-called layer may comprise a plurality of material layers including compositionally distinct layers and is not limited to a single layer or composition. Further, in alternate aspects, the first and second layers are optionally repeated or layered to comprise an alternating plurality of layers, as will be described in more detail below.

Thus, variations and modifications can be made in material compositions that form the layers, which are treated in accordance with the methods of the present disclosure. A layer can optionally include any number of materials or films of any thickness. In various aspects, the first layer has a first ablation threshold (energy required to produce damage) and the second layer has a second ablation threshold. The “ablation threshold” of a material is defined as the minimum incident laser fluence (where fluence is laser pulse energy per unit area defined by an 1/e² beam radius) required to remove matter from its surface with a single laser pulse. The ablation threshold is distinct from the modification threshold or melting threshold of a material, neither of which necessarily involves material removal. Furthermore, multiple-pulse laser ablation threshold has been found to be lower than the single pulse laser ablation threshold for many materials.

In certain aspects, the first ablation threshold is less than a second ablation threshold. Thus, the first layer absorbs the applied laser energy to at least partially damage (e.g., ablate) the first layer at the interface between the first layer and the second layer. In this manner, the microscale structure is formed which has a major elongate axis. Methods of applying ultrashort pulsed laser energy to multiple layers to ablate at least one of the layers is more fully described in J. P. McDonald, “Near Threshold Femtosecond Laser Interactions With Materials: Ablation Thresholds, Morphologies, And Dynamics,” Doctor of Philosophy Dissertation for Applied Physics at the University of Michigan (submitted electronically for publication Aug. 26, 2007 and scheduled for electronic publication on Jan. 1, 2008), which is herein incorporated by reference in its entirety.

As described previously above, various materials are suitable for use with the present disclosure, and optionally comprise any combination of a plurality of layers in which laser energy can be largely deposited at the interface between two layers, where there is an ablation threshold mismatch between at least two of the layers of the plurality. While not limiting the present disclosure to any particular theory, it is believed that the location of laser energy absorption in the bulk of the multi-layer substrate is important (e.g., at the interface between the first and second layers) to the blister/void space formation, particularly where an ablation threshold mismatch exists.

Thus, in certain aspects, the disclosure provides methods where applying the ultrafast laser energy ruptures the second layer from the first layer to form a groove (an open shape) having the major elongate axis along the substrate surface. In certain preferred aspects, the application of the ultrafast laser energy creates a void space between the first layer and the second layer, in a process that is believed to be delamination, thereby forming a channel (with void space between the first and second layer) that has a major elongate axis along the substrate surface. The laser induced ablation or damage to the first layer results in a separation (e.g., delamination) of the second layer from the first layer. The second layer is then free to expand upward from the underlying first layer by either release of compressive stress or by the force supplied by the laser induced ablation or damage to the first layer. In certain aspects, the amount of energy applied by the ultrafast laser determines whether the second layer entirely ruptures to form a groove, or remains in place but delaminates from the substrate surface to form void space (a blister or bubble) that creates a channel between the first and second layers.

Generally, the applied laser energy fluence (net pulse energy per unit area) exceeds at least the ablation threshold for the first layer. In certain aspects, for certain materials, a fluence of the pulse of applied laser energy is greater than about 0.8 J/cm². However, as appreciated by those of skill in the art, such fluence energies are highly dependent on the materials and systems selected to form the first and second layers, respectively, and suitable fluence energies can vary widely. In certain aspects for certain material systems, where the fluence of the pulse of applied laser energy applied to the substrate surface is less than the second ablation threshold energy of the second layer, but is greater than the first ablation threshold energy of the first layer, a separation process, believed to be a delamination or buckling process, occurs where void space forms between the first and second layers to form a channel in the region near where the laser energy is applied. In some aspects, a fluence of the pulse of applied laser energy is less than about 0.8 J/cm² to form void space and hence a channel between certain first and second layer materials, as will be described in more detail below. In an exemplary case, for a 1200 nm plasma enhanced chemical vapor deposited (PECVD) silicon dioxide (SiO₂) film on a crystalline silicon substrate (Si(100), an incident laser fluence between about 0.35 to 0.42 J/cm² produces the most uniform voids or channels between the delaminated film and underlying substrate, while an incident laser fluence of about 0.7 to about 0.8 J/cm² was found to rupture the film from the substrate.

While not limiting the present disclosure to any particular theory, it is believed that the mechanism responsible for the observed discrete removal of the second layer occurs by laser pulse coupling to the interface between the first and second layers, where defects lead to a localized enhanced laser absorption, resulting in a sudden breakdown of material at the interface. The second layer will be entirely removed and a groove formed when the ablation event at the interface between the first and second layer yields a force upward on the second layer that results in fracture of the film. Thus, it is believed that the surface film is not ablated in the usual sense that occurs with conventional lasers. Rather, the portion of the second layer removed during this process is believed to be ejected from the surface as a solid disc. Thus, in certain aspects, applying of laser energy results in an ejecting a solid form corresponding to each discrete pulse of laser energy applied. While not limiting, this ejection phenomenon is believed to occur for sufficient laser fluence with ultrafast pulsed laser application to second layers having a thickness of about 10 nm to greater than about 1200 nm.

Hence, in various aspects, the disclosure is applicable to forming channels in a device, including microchannels. In such methods, laser energy generated by an ultrafast pulsed laser is applied to a surface of a substrate, where the substrate comprises a first layer which is in contact (for example, chemically bonded or otherwise adhered) with a distinct second layer. The first layer has a first ablation threshold that is less than the applied laser energy and the second layer has a second ablation threshold that is greater than the applied laser energy. The laser energy penetrates through the second layer to the first layer. A void space is generated between the first layer and the second layer, which forms a channel having a major elongate axis. The cross-sectional area and volume of the channel are sufficient to permit the channel to receive, transfer, and/or store materials, including fluids and solids.

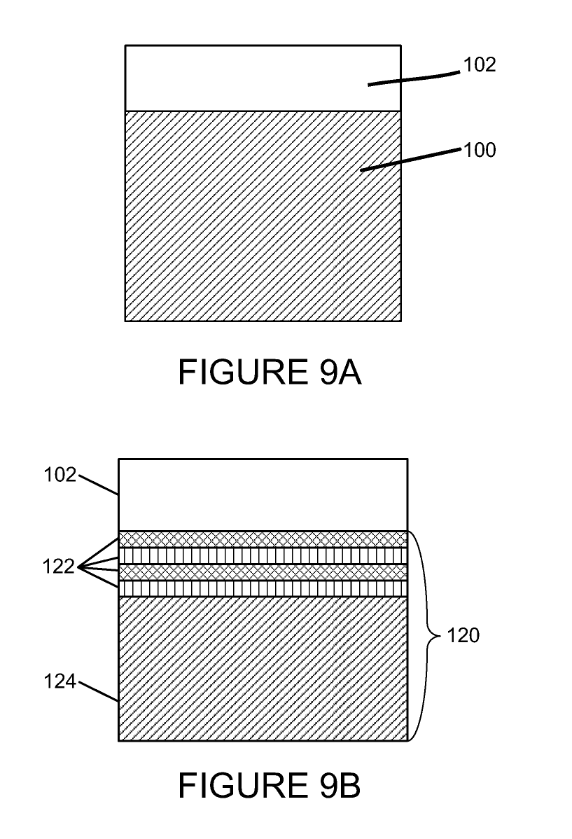

The material system including the first and second layers can comprise any film and/or substrate combination where ultrafast laser energy can be largely deposited (i.e., the first layer or substrate transmits less than about 10% of the incident laser intensity) at the interface of the second layer (e.g., film) and first layer (e.g., substrate). In other words, the fs laser ablation threshold of the second layer (e.g., a film) is preferably greater than that of the first layer (e.g., a substrate). Furthermore, the first layer material may optionally comprise a plurality of thin films insofar as these films absorb the laser energy (e.g., ablation or modification of material is produced) while the first layer does not absorb such energy (see FIGS. 9A and 9B).

In various aspects, the material (or combination of materials) forming the second layer is largely transparent to applied incident laser light. By “largely transparent” it is meant that greater than or equal to about 80% of the incident laser light permeates and/or passes through the material; optionally greater than or equal to about 85%; optionally greater than or equal to about 90%; and in certain aspects, optionally greater than or equal to about 95% of the incident laser light passes through the material. In various aspects, the material (or combination of materials) forming the first layer absorb incident laser light and thus less than or equal to about 15% of the incident laser light passes through the material (or greater than or equal to about 85% of the incident laser light is absorbed by the material); optionally greater than or equal to about 90%; optionally greater than or equal to about 95%; optionally greater than or equal to about 97%; and in some aspects, optionally greater than or equal to about 99% of the incident laser light is absorbed by the first layer material.

In FIG. 9A, a first layer 100 is disposed beneath a second layer 102. In certain aspects, the first layer 100 is a substrate and the second layer 102 is a film, such that the second layer 102 has a reduced thickness as compared to the first layer 100. In FIG. 9B, a first layer 120 comprises a plurality of distinct layers 122, including a primary substrate layer 124 and a secondary substrate layer 126 which optionally includes a single layer or a plurality of layers. As shown the secondary substrate layer 126 is a stack of thin metal or semiconductor films, which absorb the applied ultrashort laser energy pulses. The second layer 102 is similar to that shown in FIG. 9A.

Suitable first layer materials include metals, such as gold (Au), copper (Cu), aluminum (Al), copper (Co), cadmium (Cd), yttrium (Y), platinum (Pt), nickel (Ni), indium (In), iridium (Ir), alloys, equivalents, and combinations thereof. Other suitable materials for the first layer comprise semiconductors, such as silicon (Si), germanium (Ge), carbon (C), gallium arsenic (GaAs), indium antimony (InSb), and combinations and equivalents thereof. The second layer is optionally in the form of a surface thin film and optionally comprises oxides, such as silicon dioxide (SiO₂), aluminum oxides (Al₂O₃); dielectrics, such as polymers which are transparent (e.g., transmit greater than about 80% of the incident laser intensity) at the wavelength of the incident laser beam.

Thus, in various aspects, the first layer comprises a material that absorbs the applied laser energy. For example, the first layer is optionally formed of silicon (100). In certain aspects, the first layer comprises a material that comprises silicon or a nickel-based superalloy CMSX-4 (having a Ni₃Al phase dispersed in a nickel gamma-phase matrix).

As discussed above, the second layer comprises a material that is transmissive/transparent to the laser energy (where a void space is to be formed between the first and second layers). For example, a suitable material for the second layer includes silicon dioxide or indium tin oxide, or any transparent oxide, transparent polymer, or mixtures thereof. In certain aspects, the second layer comprises silicon dioxide (SiO₂). For example, the second layer is optionally selected from the group of thermally grown oxide (SiO₂) and plasma enhanced chemical vapor deposited (PECVD) oxide (SiO₂) films, and mixtures thereof. Here “transparent” is defined with respect to the wavelength of the incident laser pulse. Thus, in some aspects, the ablation threshold energy of the first layer is about 0.2 J/cm². In certain aspects, the ablation threshold energy of the second layer is greater than about 1 J/cm².

While not limiting the present teachings to any particular theory, it is believed that the stress state of the first layer, particularly in the form of a thin film, is related to the ease with which voids or channels are produced via the femtosecond laser direct writing technique. The transparent first layer is believed to posses an intrinsic compressive stress, which is typically obtained due to growth conditions. For example, the magnitude of the intrinsic compressive stress in the thermally grown SiO₂ and PECVD grown SiO₂ films is 400 MPa and 300 MPa, respectively. However, it is hypothesized that higher compressive stress occasionally results in cracking or fracture of the SiO₂ films, once the first layer has been delaminated from the substrate or second layer, thus control of the transparent first layer film's compressive stress is potentially an important variable to consider when using such material systems. By way of example, a 1200 nm thermally grown oxide film selected as the second layer may be more prone to fracture due to presence of greater intrinsic compressive stress relative to the oxide films prepared via PECVD. Compressive stress of the first layer can be controlled through modification of growth techniques and/or post treatment of the film following deposition.

In various aspects, while not limiting the present teachings to any particular mechanism, it is further believed that the location of the energy absorption in a substrate having a plurality of layers is important to the delaminating process. In contrast to prior art methods of forming blisters, where nanosecond laser irradiation of aluminum thin films on glass substrates produced delamination driven mostly by thermal effects in the metallic film, the physical mechanism for the present methods of delamination (e.g., blister and/or void formation) is different due to laser induced ablation of the energy absorption in the underlying second layer produced by the ultrafast laser, which separates regions of the first layer. In contrast to other prior art delamination techniques, the deterministic nature of fs laser pulses desirably allow for greater control of feature characteristics. Conventional, direct-write techniques have not provided such precision, which is highly desirable.

The present teachings provide methods of writing channels or features with a high level of precision, where the channel dimensions are highly controlled (+/−20 nm height variation and +/−100 nm width variation). Additionally, in contrast with other direct-write techniques for producing fluidic channels, the method of the present disclosure has the advantage of involving only a single processing step for channel production. Additionally, in contrast to prior attempts at laser-machining channels within bulk materials, the ultrafast pulsed laser thin film delamination technique discussed here generates far less debris during channel production, so that channels are not clogged during production. This eliminates additional processing time required to eliminate debris and produce a channel free of debris. This further adds to the desirability of use of the femtosecond direct write technique for micro and nano-fluidic applications. Due to the relatively small amount of laser power that is required to produce channels, parallel processing is contemplated, which is not available with other techniques.

The methods of the present disclosure are particularly useful in applications of fluid control and lab-on-a-chip technologies, where electronic sensing and control of fluids at the nano-scale is important. In some aspects, the present disclosure provides a method of forming a microscale structure having a major elongate axis along the interface between a silicon containing layer and an SiO₂ containing thin film layer. The method comprises applying laser energy generated by an ultrashort pulsed laser to a surface of the substrate. The substrate comprises a first layer comprising silicon which is in contact (optionally chemically bonded or otherwise adhered) with a second layer comprising thermally grown or PECVD silicon dioxide (SiO₂). The ultrafast laser energy forms the microscale structure having the major elongate axis. In certain aspects, the applying of laser energy ruptures the first and second layer to form a groove having the major elongate axis along the substrate surface. In other aspects, the applying of laser energy creates a void space between the first layer and the second layer, thereby forming a channel having the major elongate axis along the substrate surface.

In certain aspects, the first layer comprises silicon (e.g., Si(100) and the second layer comprises silicon dioxide (SiO₂), thus the channels are optionally produced (second layer ruptured or completely removed) in a silicon dioxide layer having a thickness ranging from less than about 20 nm to greater than or equal to about 100 micrometers, optionally from about 25 nm to about 1200 nm. In certain aspects, suitable substrates have a second layer of thermally grown SiO₂ films have a respective thickness of about 20 nm, 54 nm, 147 nm, and 1200 nm over a first layer comprising Si(100).

In certain aspects, ultrashort (e.g., femtosecond (fs)) pulsed laser damage of substrates formed of a first layer comprising Si(100) further having a second layer formed of a thin thermal oxide (SiO₂ or glass) films at about 20 nm to about 100 μm thickness, demonstrate the advantages of certain phenomena that are believed to occur when the ultrashort laser pulse interacts with such a material structure. While not limiting the present disclosure to any particular mechanism, the first such phenomenon is where the second layer of thin glass film is cleanly removed from the substrate resulting in limited damage to the remaining material in a process that is similar to selective lithographic removal of thin films. With the second phenomenon, the interaction of the ultrafast laser pulse with the material results in a delamination of the film (thermally grown or PECVD silicon dioxide) from the substrate. The second layer of glass remains intact in regions outside where the laser energy is applied, which results in a void space or blister forming between the glass and the underlying substrate in the region where the laser energy is applied. In this manner, the disclosure provides for a continuous void space to be formed by a plurality of single blisters which are overlapped. Such void space produces a channel having a major elongate axis that can be used in certain aspects as a fluidic channel having a range of dimensions suitable for nano- and micro-fluidics.

As described above, silicon/silicon dioxide systems have broad industrial applicability to many different industries, including by way of example, microelectronic devices and nano- and micro-fluidics bioassay/“lab-on-a-chip” applications. The methods of the disclosure provide “direct-write” processes for device production that are performed with relative ease, relatively high speed, high reproducibility, and with relatively low cost.

In certain aspects, the present disclosure produces channels having a cross-sectional shape along the major elongate axis that is optionally of a noncircular geometry. The channels are physically stable after being generated by the applied laser energy. In various aspects, a major advantage of the processes of the disclosure is that the formed channel has a cross-sectional area that is substantially uniform along the major elongate axis. By “substantially uniform” it is meant that the cross-sectional area at any point along the major elongate axis (i.e., the length of the groove and/or channel structure) varies less than 10% from any other cross-sectional area along the major elongate axis, preferably the cross-sectional area varies less than about 5%, even more preferably less than about 3%, and in some cases, varies less than about 1%. In this manner, the processes of the invention provide a highly controlled and reproducible method of forming void spaces along the predetermined path on the substrate to form a channel having a relatively uniform cross-sectional area and hence a uniform volume along the length of the channel (or along the major elongate axis). The ultrashort pulsed lasers provide highly reproducible, high resolution, precise channels that can be employed to make multiple channels having the same volume.

In certain aspects, the present disclosure provides a method to produce structures in a second layer of a substrate, for example, SiO₂ thin films (having varying thicknesses) on a first layer, e.g., Si(100) via select removal of the SiO₂ layer using a femtosecond pulsed laser. In addition, the disclosure provides a simple system with measurable characteristics that can be used to verify computer models of femtosecond laser-solid interaction.

Other advantages of employing an ultrashort pulsed laser for direct-write lithography techniques as described herein include minimum collateral damage caused by the ultrashort laser pulses as compared to other pulsed lasers and parallel processing ability in that a single laser and single translation stage could be used to produce in excess of 100 features simultaneously on multiple substrates, or 10 or more features on a single substrate.

In one aspect of the disclosure, an exemplary laser is a femtosecond pulsed laser that comprises an amplified, 150 fs pulsed laser operating at a wavelength of 780 nm, 1 kHz repetition rate, 800 mW average power, 800 μJ per laser pulse. As described above, a non-limiting suitable example is the commercially available fs pulsed laser is the CPA-2001 sold by Clark-MXR, Inc., where an average laser power that is used is optionally approximately 0.1 to about 1% of the available output of the laser (typically 6-8 mW). Thermal oxide film removal resulting from a single laser pulse can be verified by atomic force microscopy (AFM) for all film thicknesses. In order to produce regions in which the film is removed (i.e., lines, shapes, etc.), a target substrate can be translated automatically by a motorized translation stage (such as the ESP7000 motion controller with ILS series translation stages commercially available from Newport Corp. of Mountain View, Calif., U.S.A.) in the focal plane of the laser.

In certain aspects, minimum feature size relates to the film thickness and the laser focusing conditions. In certain aspects, channel structures can be formed with a width of greater than or equal to about 100 nm to less than or equal to about 1 mm; optionally from greater than or equal to about 100 nm to less than about 20 μm. Under optimal focusing conditions of the ultrafast laser, line or track widths can be formed having a width of less than about 100 nm, optionally less than about 50 nm, optionally less than about 25 nm, and optionally less than about 10 nm can be formed in a second layer formed of thermal oxide films having an exemplary thickness of about 20 nm.

The speed with which features are formed by the laser on the surface of the substrate relates to the feature size and the repetition rate of the laser, with smaller features generally taking longer to create. The rate of laser writing is dependent on the material characteristics and the amount of energy applied, which also relates to the incidence angle of the laser beam. A write rate that is too rapid may cause fracture or rupturing, while a write rate that is too slow may result in insufficient channel formation. In various aspects, a write rate can be controlled at speeds of about 1 μm/s to about 10 cm/s, with a feature size ranging from less than 100 nm to greater than about 1 cm. In certain aspects, the feature or channel size is about 5 μm to about 150 μm. In some aspects, the channel length has a minimum of about 2 μm and can be of any length desired.

The focusing conditions (including lens focal length and incident beam direction) of the laser can be varied to change the diameter and therefore height of fluidic channels. In certain aspects, the processing environments can be varied to product beneficial microfluidic channel/capillary production, such as, producing channels under fluid or vacuum, or while applying heat to one or both of the first and second layers.

In certain aspects, linear structural features, or channels, have a 20 μm width and 300 nm height produced with an arbitrary length in 1200 nm thick second layers (thermal oxide films) at a speed of 1 cm/s. In certain applications, damage to the substrate is minimized by directing the laser beam onto the sample surface at non-normal incidence angle.

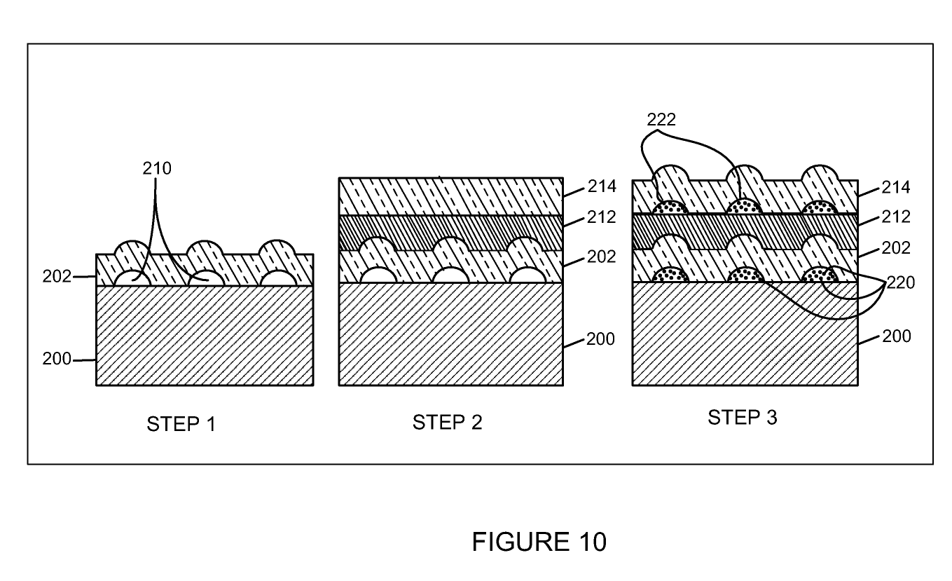

Parallel processing of multiple channels is contemplated to decrease production time and ease. In certain aspects, production of three-dimensional channel networks may also be achieved by first producing voids between a second layer film and a first layer substrate, followed by deposition of an additional pair of first layer absorbing material and second layers of transparent material on top of the first layer, which is then followed by the channel or void writing process (see FIG. 10, which will be described in more detail below).

Advantages of the ultrafast laser direct write technique further provide for producing fluidic channels and networks with a single processing step, and increased quality control by rapidly creating a device from a bitmap file of the desired device, so that changes in device design can be quickly evaluated. In accordance with certain principles of the present disclosure, heightened and responsive quality control is also provided by virtue of the fast and simple manner in which fluidic channels are created using ultrashort pulsed laser direct write technique. Changes in device function and design can be rapidly implemented and evaluated by modifying bitmap images of the desired device. In addition, devices may be integrated so that devices capable of sensing or manipulating fluid in the channels can easily be pursued by exploiting the electrical properties of the material structure forming the first and second layers, for example, SiO₂ on Si(100). Macro to nano interfacing is optionally achieved by encasing the device in PDMS, a commonly used material for micro-fluidics.

Direct write laser lithography techniques involve a single processing step, while techniques such as electron beam and photo lithography can take several steps, each of which provide additional opportunity for production error. Previous attempts at producing fluidic channels by electron beam lithography and other processing steps to delaminate thin diamond like carbon (DLC) films from a Si(100) substrate generally introduce waste and add to overall device production time. Additionally, such methods may provide damaged channel structures that may have debris formed therein. Furthermore, the ultrashort pulsed laser direct write techniques of the present disclosure are industrially practicable, easily achieved, and in certain aspects, allow for parallel processing. Such advantages are not available for conventional electron beam lithography techniques. In addition, laser based techniques can be performed without the use of clean rooms or potentially dangerous chemicals.

Further, within the specific realm of laser lithography, ultrashort pulsed lasers have a unique advantage over longer pulsed lasers (such as nanosecond pulsed lasers) in that the collateral damage produced in the first layer, for example, a Si(100) substrate, is far lower, such that no cracking or melting is visible beyond an area extending about 10 to 100 nm into the material surrounding a laser damage feature. Although some ablation of the substrate may occur, the processes of the present disclosure provide limited thermal diffusion uniquely associated with ultrafast (e.g., fs) laser interaction which provides material immediately in the vicinity (about 50 nm) of the laser-affected region desirably maintains the bulk crystalline properties of the first layer, for example, Si(100). Thus the integrity of the desired device (for example, a metal oxide semiconductor field effect transistor (MOSFET)) can be maintained in accordance with the principles of the present disclosure, while the throughput of production is increased.

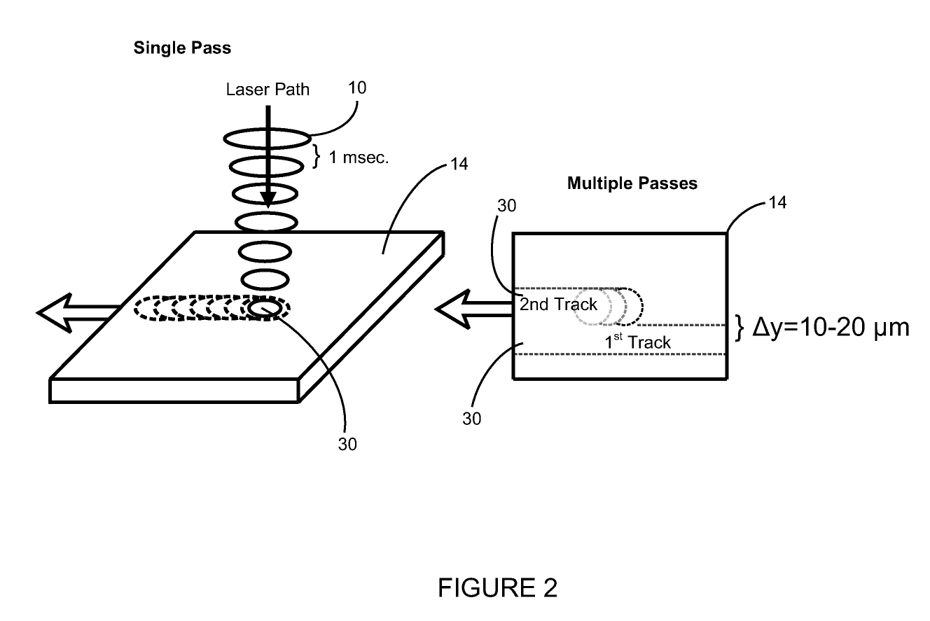

In FIGS. 1 and 2, a laser beam pulse 10 is generated by an fs pulsed laser 12 and directed toward a substrate 14 incident from right. One or more neutral density filters 16 are used to control the intensity of the incident laser beam 10. The laser beam 10 is focused onto the substrate surface 14 with a focusing lens 18. Various types of lens known in the art (focal length, and piano-convex, bi-convex, or achromatic) may be employed as lens 18. In certain aspects, a fast acting shutter 20 is optionally used to select single pulses from train of pulses in the laser beam 10. The sample substrate 14 is placed on a mount 22. In certain aspects, the mount 22 has tilt control, while an automated 4-axis (3 translation, 1 rotation) motorized stage 24 is operable to translate the substrate 14 in the focal plane. Channels 30 are optionally characterized with optical microscopy (OM), atomic force microscopy (AFM), and scanning electron microscopy (SEM).

In certain aspects, the present methods can be used to apply laser energy to a region of the surface of the substrate that corresponds to a single path or track, where voids are formed adjacent to one another along a single axis to generate a channel (FIG. 2). In other aspects, the methods of forming channels on a surface of a substrate include applying laser energy generated by an ultrashort pulsed laser to a region of the surface of the substrate, which forms a first track or “single pass” such as shown in FIG. 2. The method also comprises applying a second track of laser energy distinct from the first track along the surface of the substrate. Thus, a channel is generated that comprises a first void space corresponding to the first track formed in the surface and second void space corresponding to the second track, where at least a portion of said first void space and said second void space overlap to provide a larger volume of the channel than a single track alone would permit. Since the present methods are highly reproducible, the void spaces are likewise of substantially the same shape and size, thus the overlapping of different tracks is possible to generate wider channels, while maintaining substantially the same height across the entire span of the channel. A plurality of such tracks or patterns can be generated to form a variety of shapes, configurations, and channel sizes on the substrate surface, as discussed in more detail below.

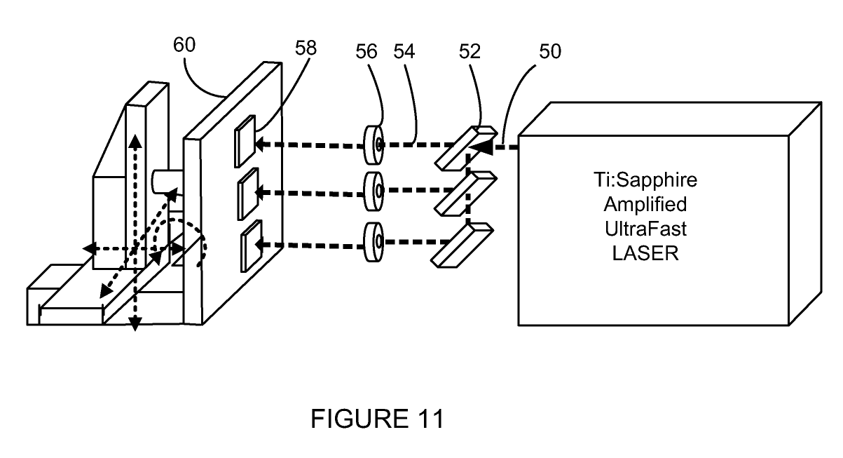

Further, as described above, in certain aspects, the average laser power used to perform lithography with a commercially available ultrafast pulsed laser is optionally less than about 1% of the total average output power of the laser. Thus, parallel processing of various features can be conducted by splitting a single laser beam into multiple beam lines, each of which can be focused onto a common or multiple substrates on which ultrafast laser direct write lithography is then performed. As shown in FIG. 11, parallel processing splits a single laser beam 50 into several beam lines 54 via beam splitters 52, which then pass through a plurality of focusing lenses 56. Beam lines 54 are each capable of producing channels and/or grooves on the same or different substrates 58 controlled by a common translation stage 60. The femtosecond laser direct write technique for producing nano- and micro-fluidic channels is a useful alternative to traditional multi-step lithography-based techniques and, due to the convenient SiO₂ on Si structure, the technique is well-suited for incorporating electronic sensing and fluid manipulation into fluidic or micro electromechanical systems (MEMS).

Variations and modifications can also be made to processing conditions of the present disclosure. The focusing conditions (including lens focal length and incident beam direction) of the laser can be varied to change the diameter and therefore height of fluidic channels. Focusing conditions of the laser are optionally varied to produce lines or shapes, i.e., discrete regions, free of the second layer, where such regions extend from greater than about 10 nm to about 10 mm. Such discrete regions can be formed by using a chirped pulse amplifier (CPA) based laser. The technique of the present disclosure can be performed in any environment, particularly in fluids which may enhance material removal. In certain applications, a specific processing environment may be beneficial, for example, for capillary production the channels may be produced in the presence of fluid or a vacuum. Alternately, the substrate may be heated during application of the laser energy. Parallel processing and integration with software programs further decreases production time and industrial practicability.

In accordance with various aspects of the present disclosure, direct write laser lithography forms “discrete” removal of the second layer (e.g., oxide film) with minimal collateral damage to the first layer/substrate. This is due to the use of an ultrafast laser for direct write lithography in accordance with the present disclosure, such as a femtosecond laser. The process has enormous versatility and is useful for many lithographic applications including microelectronic mechanical systems (MEMS), microelectronics, or biological (medical) devices. Further, the methods of the disclosure contemplate the formation of layered arrays of substrates and films having channels or grooves, as different substrates having channels and/or grooves are assembled together in different configurations. Channels produced in this fashion may be used for delivering coolant to microelectronic devices.

Further, the vast applicability of various common electronic materials, such as SiO₂ on Si(100), in various electronic devices reveals the great number of applications for both sensing and manipulating fluid traversing fluidic networks. In certain aspects, the microfluidic devices made in accordance with the principles of the present disclosure provide for DNA or other macromolecular classification, sorting, and/or characterization. In other aspects, the channels may contain or store a solid material, which can potentially fill the channels by introducing fluids, for example, melted materials, sedimentation, or precipitative deposition; or by using other techniques, such the non-limiting examples of chemical vapor deposition or photo-reactive deposition.

The methods of the present disclosure are of considerable utility in applications requiring fluid control and lab-on-a-chip technologies, where electronic sensing and control of fluids at the nano-scale is important. In contrast to other delamination techniques, the deterministic nature of ultrashort (e.g., fs) laser pulses allows for great control of feature characteristics. As described above, due to the relatively small amount of laser power that is required to produce channels, parallel processing can be pursued which is not available with other techniques.

In certain aspects, the present disclosure provides a method of forming a device, such as an element for an electrochemical cell like a battery or fuel cell. In general, batteries or fuel cells are power source devices that convert chemical energy into electrical energy, by means of an electrochemical oxidation-reduction reaction. Electrochemical cells can be used as a power source for various applications.

Batteries can generally be described as comprising three components: electrodes including an anode that contains an active material that is oxidized (yields electrons) during discharge of the battery (i.e., while it is providing power) and a cathode that contains an active material that is reduced (accepts electrons) during discharge of the battery; and an electrolyte active material that provides for transfer of ions between the cathode and anode. Batteries are characterized by the specific materials that make up the electrodes and electrolytes. Selection of these components can yield batteries having specific voltage and discharge characteristics that can be optimized for particular applications.

For example, batteries containing lithium and sodium are desirable, because such metals are light-weight and have high standard potentials. By way of example, lithium batteries typically comprise from one or more lithium electrochemical cells containing electrochemically active (electroactive) materials. Among such batteries are those having metallic lithium anodes and metal oxide cathodes, typically referred to as “lithium metal” batteries. The electrolyte typically comprises a salt of lithium dissolved in one or more solvents, typically nonaqueous aprotic organic solvents. Other electrolytes are solid electrolytes (typically polymeric matrixes) that contain an ionic conductive medium (typically a lithium containing salt dissolved in organic solvents) in combination with a polymer that is optionally ionically conductive, but electrically insulating.

A wide variety of electrochemical cell systems can be assembled in three dimensions, such as a three-dimensional thin film battery. Electrochemical cells formed in accordance with the present teachings will provide a very high power/energy density at a very low processing cost. In one example, a three dimensional channel production technique is shown in FIG. 10, where a first absorbing layer 200 is overlaid with a second layer 202, which is a solid state electrolyte transparent film. By further way of non-limiting example, thin film batteries generally employ a solid lithium ion conducting electrolyte, such as LiSiCON, Li₄SiO₄—Li₃PO₄ solid solution, Li₂O—B₂O₃—SiO₂, Lipon (lithium phosphorous oxynitride), and the like. The geometries formed permit the use of any common electrolytic systems, and are not limited to those described herein. Such electrolytic systems include lithium based or magnesium based systems, including liquid or solid anodes and cathodes, which can potentially fill the channels. Here, the second layer 200 is selected to be a conductive metal suitable for use as an electrode.

In a first step, channels or voids 210 are produced with femtosecond laser write process between the first layer film 200 and second layer substrate 202, produced in accordance with the teachings described above. As shown in FIG. 10, a first set of channels 210 are produced between the solid state electrolyte 202 and the underlying metal substrate 200, the channels 210 are optionally filled with an additional active material 220, such as a lithium electrolyte, to create the battery cell. In certain aspects, the three dimensional battery comprises additional channel layers. For building optional layers into the three-dimensional battery as desired, additional steps include depositing another layer of material 212, for example a metal, over the initial transparent solid state electrolyte first layer 202 and subsequently depositing another fourth material layer 214, for example a solid state electrolyte, over the third layer 212. The material compositions of the respective material layers may be varied and further any technique or combination of techniques which produces thin films of materials (chemical vapor deposition, molecular beam epitaxy, spin coating and the like) are contemplated for the deposition process. In a third step, another set of channels 222 is formed between the metal layer 212 and the solid state electrolyte 214. Such a process (Steps 1-3) can be repeated as many times as desired. When the formation of the battery architecture is complete, the various channels, for example, 210, 222 are optionally filled with the additional active material 220. While the battery device described above is merely exemplary, the present techniques can be applied to any number of variations in appropriate materials and electrochemical cell architectures.

Other electrochemical cells include fuel cells. Exemplary fuel cells react hydrogen and oxygen to generate electricity. One suitable and non-limiting example is a polymer electrolyte membrane fuel cell, which includes a thin, solid polymer membrane-electrolyte having an anode on one face and a cathode on the opposite face of the membrane-electrolyte. The cathode, membrane-electrolyte, and anode are typically referred to as a membrane electrode assembly (MEA). The MEA is typically disposed between a pair of electrically conductive current collectors. A fuel cell stack comprises a plurality of the MEAs stacked together in electrical series. The MEAs can be separated from one another by an electrically conductive contact element, known as a bipolar plate, which electrically conducts current between the adjacent cells. Often, heat transfer channels are within or adjacent to the bipolar plates in the fuel cell stack, where a heat transfer medium is circulated to heat the stack during cold-start conditions and to cool the stack during operation. The methods of the present disclosure are optionally used to form heat transfer flow channels in the bipolar plate or other heat transfer devices. It should be noted that the channels formed according to the present disclosure optionally form flow field channels for delivering reactants, such as hydrogen and/or oxygen to the MEA for reaction.

Further, in certain aspects, the interior volume of each channel may receive and circulate a heat transfer medium, as where the exterior surface of the substrate (where the second layer is raised) forms a contrapositive flow field for the fuel cell reactants. It should be noted that the use of the present methods in forming channels in bipolar plates provides an integral material with channels that eliminates concerns with many conventional ways of forming such materials, including issues with adhesives, brazing, and other issues. Furthermore, protective surfaces, such as polymers and glass are highly advantageous for a fuel cell environment, where the corrosive environment otherwise attacks conductive metals. The methods of the present invention are widely applicable to various elements in electrochemical devices, such as fuel cells, batteries, and the like.

In certain aspects, the present methods are particularly suitable for providing rapid prototyping with the femtosecond laser direct write method to facilitate optimization of battery design or electrochemical cell designs. In yet other aspects, the present disclosure provides a hydrogen storage device. The hydrogen storage device formed in accordance with the present techniques forms a plurality of channels, which can be filled with pressurized hydrogen for storage and future use on small-scale, chip level hydrogen powered devices. Storing hydrogen in a solid material provides relatively high volumetric hydrogen density and a compact storage medium, which is particularly advantageous for mobile applications. Hydrogen stored in a solid is desirable since it can be released or desorbed under appropriate temperature and pressure conditions, thereby providing a controllable source of hydrogen. However, other hydrogen storage materials are contemplated. Various solid hydrogen storage materials are hydrides, for example, simple hydrides, such as magnesium or transition metal hydrides, or complex hydrides, for example those complex hydrides represented by AB, A₂B, AB₂, and AB₅, where A and B are separate cationic species, such as sodium, lithium, calcium, aluminum, iron, titanium, lanthanum, nickel, scandium, misch metals, and/or boron, for example. After forming the channels via the write techniques described above in a multi-layer substrate, the channels are then filled with a hydrogen storage material. The channels can be filled in accordance with the methods described previously, above. In other aspects, in a similar manner to the hydrogen storage device, the present disclosure contemplates methods of forming channels in a substrate, which can be filled with dielectric materials to form a capacitor or other type of microelectronic device.

In yet other aspects, the present disclosure provides cooling channels on microelectronic devices, such as on microchips. In certain aspects, the cooling channels are produced on microprocessors in-line with other chip building steps. Chip-cooling is then achieved by pumping coolant (through conventional micro-pumping technology known in the art) through the channels, where the surfaces of the channels are in nearly direct contact with heat generating elements of the microprocessor. It should be noted that the limited collateral damage and heat affected zones unique to ultrafast laser processing will allow channels to be written once critical chip elements are in place without the risk of damaging said elements. This is a particularly beneficial aspect of the present teachings.

In other aspects, the channels produced with an ultrafast laser in accordance with the present teachings use an ultrafast direct write technique for forming features which may be used for a range of nano- and micro-fluidic applications. Examples include flow cytometry, DNA analysis, protein sorting, chromatography and the like. As described below in the examples, electrophoresis of charged nanoparticles within channels produced via an ultrafast laser direct write method are also contemplated.

### EXAMPLES

In certain aspects, the presence or absence of the native oxide of Si(100) appears to impact both the ultrafast laser induced damage threshold (laser pulse energy required to produce damage) and damage morphology. To better understand the role of thin oxide films on femtosecond laser induced damage, analysis is conducted on Si(100) samples with thermally grown oxide (SiO₂) films having a range of thicknesses (20-1200 nm). Two primary damage morphologies are observed to result from irradiation with femtosecond laser pulses. For laser fluence (J/cm²) greater than 0.7±0.1 J/cm², the thermal oxide film is observed to be removed from the substrate in a nearly discrete fashion, resulting in craters of depth approximately equal to the thickness of the film. For low laser fluence (<0.7±0.1 J/cm²), the thermal oxide film is observed to delaminate or buckle up from the Si(100) substrate forming a blister like feature. As described above, these single isolated blisters or void regions are connected together to form a connected region of delaminated film, such that capillaries or channels are produced in which the top surface of the channel is the first layer or delaminated thermal oxide film and the bottom surface is the second layer or the underlying Si(100) substrate.

### Example 1

The nano- and microfluidic channels are produced on Si(100) wafers with 1200 nm thermally grown oxide films. The thickness of the film is determined via ellipsometry. Samples are prepared for channel production by an initial degreasing scrub, followed by acetone, methanol, and deionized water baths. The source of the laser pulses is a commercially available laser (CPA 2001, Clark MXR), that produces pulses with temporal width of 150 fs at a repetition rate of 1 kHz. Each laser pulse has a central wavelength of 775 nm, and an energy of 800 μJ. The optics setup used to deliver the laser beam to the sample surface is presented in FIG. 1.

The motion of the target substrate is controlled using a three-axis motorized translation stage. To produce a single pass channel, the sample is scanned at a constant velocity of 1 cm/s along a straight path through the focused laser beam. The laser fluence that produces the most uniform cross-sectional geometries for capillaries is believed to be about 0.35 J/cm². To produce wider capillaries, single pass capillaries are overlapped laterally with a 15 μm separation. A schematic of the writing technique previously described is found in FIG. 2.

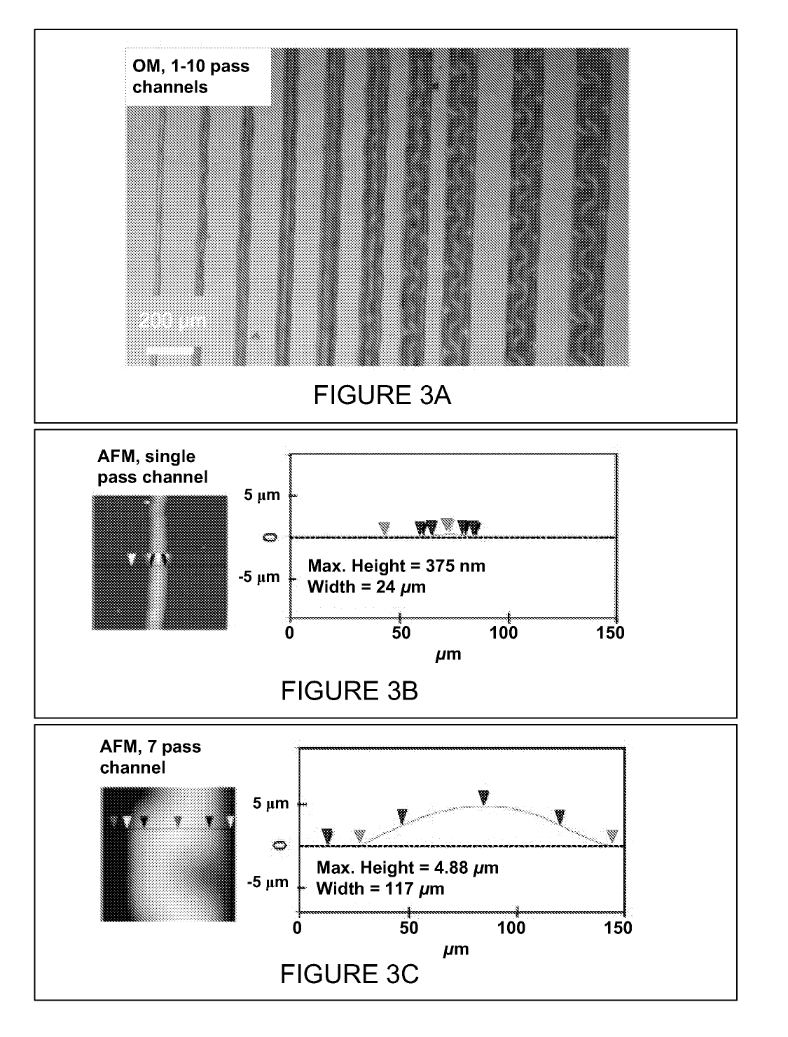

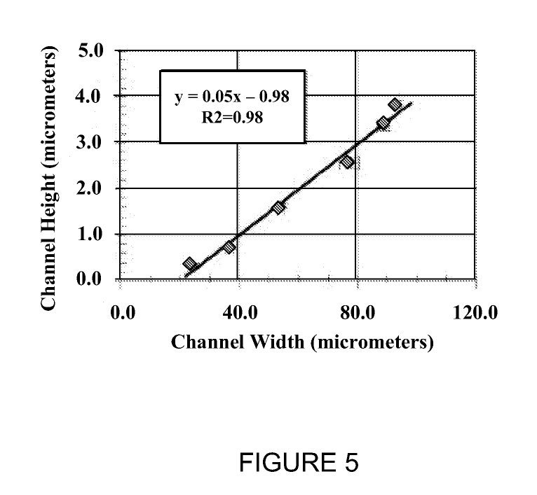

Examples of capillaries generated with the femtosecond laser direct write technique are presented in FIGS. 3A-3C. Up to a width of about 100 μm, the channels exhibit a bell-like cross section (specifically an Euler mode), while for capillaries of width exceeding 100 μm, the top surface of the channel (i.e., the delaminated thermal oxide film) exhibits the so-called “telephone cord” mode. A range of channel geometries can be formed in accordance with the present disclosure, including intersections and corners as shown in FIG. 3A. The height of a given channel is believed to be a function of its width, such that the total volume of the channel can be fine tuned by carefully controlling its lateral dimensions (see FIG. 5). Channels with the Euler mode are generated with widths of 24-95 μm, and peak heights of 355 nm-3.94 μm, respectively (measured via AFM). Channel heights are optionally about 100 nm to about 50 μm. In certain aspects, heights of greater than 2 μm, optionally greater than 3 μm can be achieved. For example, channel heights in excess of about 15 μm at a width of 320 μm are contemplated by the present disclosure.

To demonstrate the capability of the channels to carry fluids, drops of water are placed near the edge of a sample on which linear channels of a range of sizes are written off the edge of the sample surface. Viewed through an optical microscope, the channels are observed to fill with water, presumably by capillary action. Movies having a rate of 30 frames/s (yielding a resolution of 1.6 mm/s for velocity determination) show the capillaries filling with water, and these movies are subsequently analyzed to obtain flow rates. The flow rate is found to increase with increasing channel width, such that channels of widths 105-320 μm exhibit excellent flow rates of 6.2-17.5 mm/s, respectively (±1.6 mm/s).

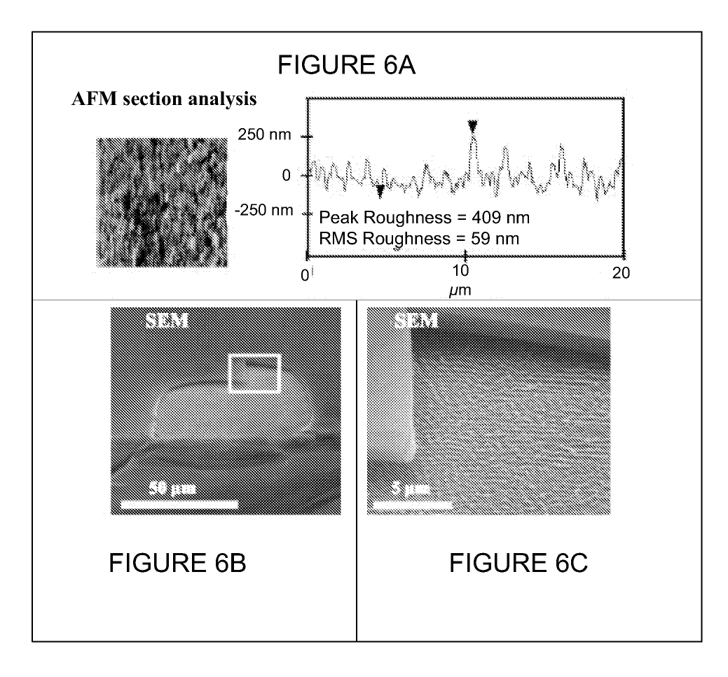

The interior surfaces of the channels are characterized using AFM and SEM. Due to the absorption of the laser energy at the first layer-second layer (substrate-film) interface, the first layer substrate is modified during production of the channels resulting in some roughening of the substrate surface. The roughness of the substrate at the bottom of a popped channel (when the laser fluence exceeds the ablation threshold of both the first and second layers, where the delaminated thermal oxide film (first layer) is completely removed from the first layer/wafer during production) is measured via AFM, yielding a rms roughness of 59 nm (see FIG. 6A). The roughness of the substrate for a channel produced under optimal laser conditions exhibits less roughness than that of a popped channel, as under optimal conditions, the net energy deposited by the laser into the material is half of that deposited when the channel is ruptured. The roughness at the bottom surface of the delaminated glass (i.e., the second layer) (observed via SEM) is less than 5 nm. FIGS. 6B and 6C. The bottom surface of the channel, the first layer forming part of the channel, exhibits surface qualities of SiO₂ as the native oxide of Si is believed to grow within a millisecond of the initial exposure of the substrate to oxygen.

While the following discussion is not limiting the present disclosure to any particular theory, the mechanism responsible for the delamination of the film from the underlying substrate is thought to rely on the location at which the incident laser energy is absorbed upon encountering the sample surface. As the thermal oxide of the second layer is largely transparent to the wavelength of the incident laser pulse, the laser energy traverses the second layer (e.g., glass) with little modification and the laser pulse deposits its energy entirely in the first layer (e.g., Si(100)) substrate. The absorption of the laser energy and subsequent melting of the first layer (e.g., Si(100)) at the substrate-film (first layer-second layer) interface produces the initial delamination of the thermal oxide film. Although the second layer does not directly absorb the energy of the incident laser pulse, it is thought that the second layer film is heated and softened both by its proximity to the molten first layer substrate and by the dense electron plasma produced upon the initial absorption of the laser energy by the first layer substrate. Once delaminated, the second layer film expands upward from the first layer due to a combination of relaxation of compressive stress present in the second layer film and the transfer of momentum from the material ablated by the action of the incident laser pulse. At laser fluences in excess of 0.7±0.1 J/cm², it is believed that the force applied on the film by the expanding ablated substrate material (first layer) exceeds the shear strength of the film (second layer), resulting in the complete removal of the second layer from the substrate.

In one example, a direct write process for producing nano- and microfluidic channels uses an ultrashort pulsed laser to selectively delaminate 1200 nm thermal oxide films from Si(100) substrates. Single pass channels with bell-like cross sections are directly written at a rate of 1 cm/s with a width of 24±1 μm and height of 355±45 nm, while larger channels up to 320 μm in width are created by laterally overlapping single pass channels. The roughness (rough mean square—rms) of the substrate surface of a popped channel is measured via AFM to be 59 nm, and the roughness of the substrate surface for a channel produced under optimal conditions is predicted to be at least a factor of two less. It should be noted that the laser pulse energy required to produce fluidic channels with the femtosecond laser direct write technique is a only 4.6 μJ, or an average laser power of 4.6 mW for a 1 kHz repetition rate amplified femtosecond pulsed laser.

Highly selective delamination and blister formation of thermal oxide films from Si(100) substrates may be achieved by using the amplified fs CPA-2001, Clark-MXR laser at an average laser power selected to be approximately about 0.6% of the available output of the laser (typically 4-6 mW). Channels of arbitrary shapes may be produced by translating a sample in the focal plane of the laser beam with a motorized and automated translation stage (ESP7000, Newport Corp.). In certain aspects, the height of the channel is a function of its width. Under optimal focusing conditions, single channels having widths ranging from about 20 to about 90 μm and heights from about 325 nm to about 4 μm are similarly formed. See for example, FIG. 5. The speed with which features can be created is dictated by the feature size and the repetition rate of the laser, with smaller features generally taking longer to create. Linear channels of about 20 μm width and 325 nm height are produced in 1200 nm thermal oxide films at a speed of 1 cm/s. Channels are optionally created by connecting regions of delaminated film (such as 100 μm squares) together in a bitwise fashion. Fluid flow into the channels by capillary action is measured and found to range from 6.2-17.5 mm/s.

Thus, in certain examples, nano- and microfluidic channels are produced by selectively delaminating 1200 nm thermally grown oxide films (SiO₂) films from Si(100) substrates using a femtosecond pulsed laser. Single pass channels exhibiting bell-like geometry cross sections have substantially uniform dimensions along the length of the channel, where widths are about 24 μm and heights are about 355 nm are directly written at a speed of 1 cm/s, while larger channels (320 μm in width and approximately 15 μm in height) are produced by laterally overlapping single pass channels.

In various aspects, the methods of the disclosure create a channel in a substrate that has a width of greater than or equal to about 100 nm to less than or equal to about 10 mm. In certain aspects, the methods of the disclosure create channels having a width on the order of about 1 mm or greater. In other aspects, the methods provide a channel in a substrate having a height of greater than or equal to about 10 nm to about 50 μm. In certain aspects, the ultrashort pulsed laser has a write speed for forming a channel of greater than or equal to about 1 cm/s, optionally greater than or equal to about 5 cm/s, and in certain aspects, greater than or equal to about 10 cm/s for a first layer having a thickness of about 1200 nm. Further, in other aspects, the laser energy is applied at a non-normal incidence angle to the substrate surface.

### Example 2

Simple fluidic devices are created with the linear blisters produced in 1200 nm thick PECVD oxide film on Si(100). The flow of water by capillary action and the flow of charged nano-spheres by DC electrophoresis are tested. The technique for producing linear blister channels that result in simple microfluidic channel features are a incident laser fluence of 0.35-0.42 J/cm², a translation speed of 0.5-1 cm/s, and a lateral channel (first and second laser track) overlap of 15-20 μm to produce wider channels (see FIG. 2). Linear channels of varying widths (single pass channels ranging from 20 μm in width up to widths exceeding about 320 μm) are drawn across a 1 cm wide sample. Thus, in certain aspects, the present methods provide the ability to create wider channels via applying laser energy by multiple passes of the laser over the surface, while still enjoying the technical advantages of the inventive process.

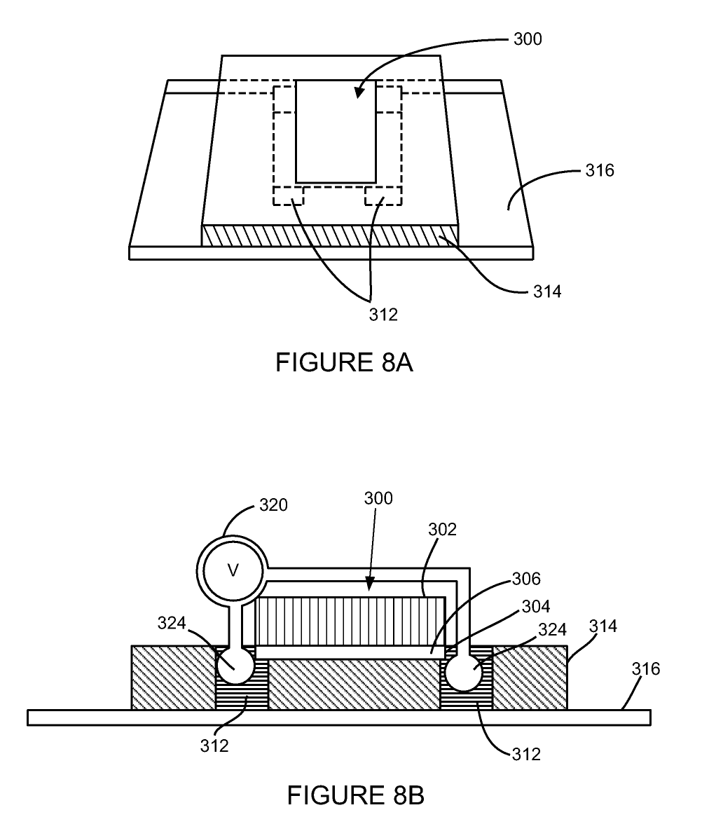

Additional experiments demonstrate that the ultrafast laser forms channels which are capable of propagating fluids. While recording video through an optical microscope, water is observed to fill linear channels via capillary action with flow rates ranging from 6.2-17.5 mm/s (±1.6 mm/s) for channels ranging in width from 105-320 μm respectively. A device is also designed for the purpose of performing electrophoresis in linear blister channels produced on Si(100) with 1200 nm PECVD oxide, such as that shown in FIGS. 8A and 8B.

In general, electrophoresis is the movement of charged particles under the influence of an electric field. Electrophoresis experiments require a means for controlling delivery of fluids to the ends of linear blister channels. This macro-micro interfacing is achieved by using a commercially available PDMS (poly(dimethysiloxane) mold from Dow Corning, SYLGARD 184™ with isolated fluid reservoirs. Several techniques for producing these molds can be employed. As shown in FIGS. 8A and 8B, a microfluidic device 300 comprising a first layer 302 and a second layer 304 with channels 306 formed therebetween is disposed over fluid reservoirs 312 formed by the PMDS mold 314, which surrounds the microfluidic device 300. The mold 314 and fluid reservoirs 312 are supported on a glass substrate 316. Voltage is applied by a power source 320 connected to leads that are placed in contact with fluid in the fluid reservoirs 312.

Electrophoretic flow in the fluid channels 306 is produced by applying a DC potential difference from the power source 320 in the respective reservoirs 312, thereby forcing charged nanospheres between the reservoirs 312 via the only available path which is through and along the length of the linear blister channels 306. The potential difference is established by placing wire leads 324 into the open tops of the reservoirs. The leads are connected to a 1250 V DC power supply (Stanford Research Systems, model PS310). The charged particles used for electrophoresis experiments are fluorescent, 20 nm diameter, carboxolate modified polystyrene spheres (commercially available as FluoSpheres™ from Invitrogen Corp.). The nanospheres have a maximum excitation wavelength of 625 nm, and a maximum fluorescence wavelength of 645 nm. The spheres are suspended in a buffered 1 M TRIS (trishydroxymethylaminomethane) solution with a 10:1 ratio of TRIS to suspended nanospheres. The nanosphere/TRIS solution are placed in one of the reservoirs with DI water placed in the other reservoir. With the electrical leads in place in the reservoirs and separated by about 1-1.5 cm, a range of potential differences are applied (5V-50V), yielding electric fields on the order of 5-50 V/cm, and currents on the order of 100's of μA. Time-lapse fluorescence microscope images demonstrates flow of particles within the channels over time.

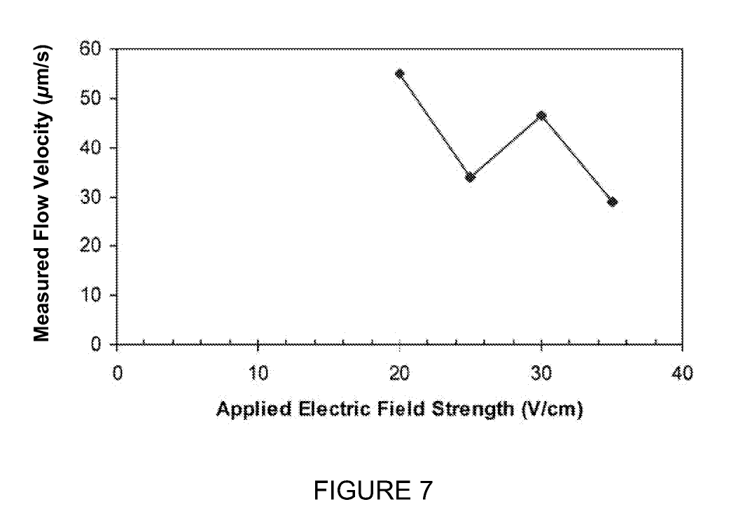

As shown by the plot in FIG. 7, the flow rate of the spheres through a particular channel is observed to generally decrease with increasing potential difference. Flow rates range from 55 μm/s to 28 μm/s for potential differences ranging from 20-35 V (fields of approximately 20 V/cm to 35 V/cm) respectively.

The decrease in flow velocity is believed to be attributed to the formation of air bubbles within and near the end of channels which limited flow of the spheres from the channels to the reservoirs. These bubbles are believed to be formed due to current leakage into the Si(100) substrate, which resulted in local resistive heating and subsequent boiling of the water and TRIS solutions. This effect can be minimized by coating the interior surfaces of the channels with insulating materials in order to achieve greater flow rates.

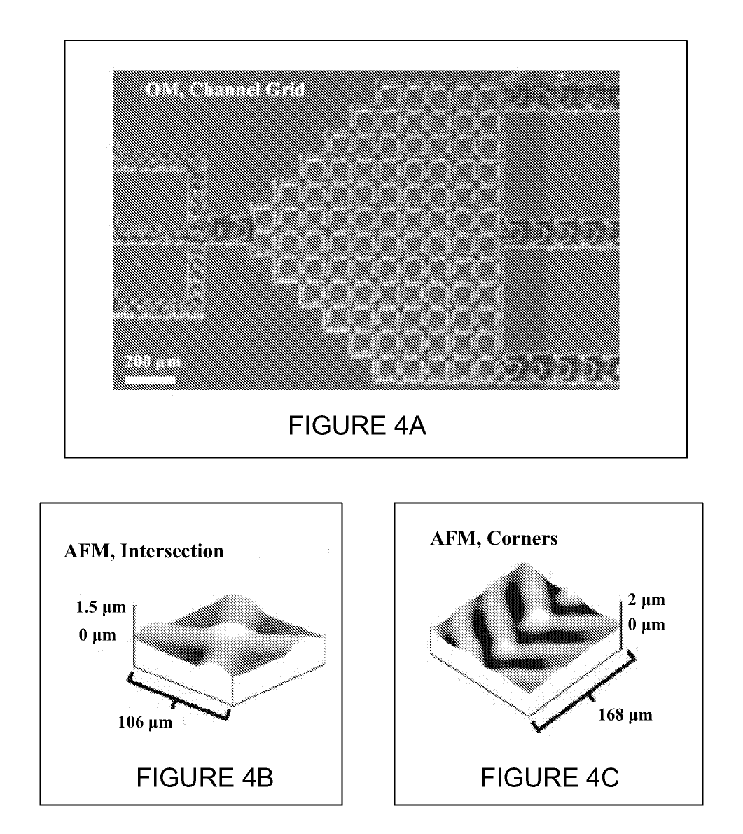

It was further observed that regions of delaminated film with arbitrary footprint could be created by simply “drawing” the desired feature with the fs laser across the sample surface. In this fashion, channel networks are assembled in square regions of film delamination on samples with the 1200 nm PECVD oxide films. This so-called “bitwise” writing technique uses a reduced laser fluence (0.3 J/cm²) and a slower scan velocity (5 mm/s) relative to the linear channel writing method. In contrast to the linear channel writing technique in which channels are produced by scanning the sample at a fixed velocity through the focused laser beam, the sample is translated in a square path (typically 50-100 μm on a side), yielding “bits” that were connected together to form desired features. An example of a simple 3-input mixing device created with the bitwise technique on Si(100) with 1200 nm PECVD oxide is shown in FIGS. 4A-4C. The top surface of channels produced with the bitwise writing technique appear to have a non-uniform cross section with the delaminated glass film exhibiting a rumpled surface. Channel intersections are easier to produce with the bitwise technique than with the linear channel writing technique, where fracture of the delaminated film at channel intersections is often observed.

FIGS. 4A-4C show examples of such bitwise device elements, including AFM views of channel intersections and corners (FIGS. 4B and 4C, respectively) that are produced by varying the translation path of the sample through the focused laser beam. This demonstrates the complexity of features that can be formed and precision of the ultrafast writing techniques.

In certain aspects, in contrast to circular channels produced with other techniques, the first layer forming a bottom portion of the channel has a greater surface roughness relative to channels produced by other methods. In some aspects, the delaminated first layer may be fragile, particularly for large channels where broad sections of the first layer are delaminated. Thus, in certain aspects, the durability of the delaminated second layer can be enhanced by embedding the entire chip in a polymer, such as poly(dimethyl siloxane) (PDMS). Polymers, such as PMDS can also be used for fluid input and output reservoirs, thus such a processing step also provides for the addition these fluid input and output reservoirs (see FIGS. 8A and 8B).

In various aspects, the methods of the disclosure provide simple, rapid processing with a laser technique, eliminating the need for multiple steps often required by conventional techniques. As discussed above, such methods can be used to form a wide variety of devices, including microelectronic mechanical systems (MEMS), microelectronics, or biological (medical) devices. Further, the methods of the disclosure employ a new ultrafast laser system that minimizes damage to the substrate material, thus having minimal collateral damage relative to other conventional laser systems. Another advantage of the present disclosure is the ability for high throughput, industrially practicable processing, where parallel processing is contemplated by a single laser and single translation stage to produce in excess of a hundred features simultaneously on multiple substrates, or alternately, a plurality of features on a single substrate.

What is claimed is:

1. A method of forming a channel on a surface of a substrate, the method comprising:
applying laser energy generated by an ultrashort pulsed laser to a region of the surface of the substrate, wherein the substrate comprises a first layer in contact with a distinct second layer, wherein said first layer has a first ablation threshold that is less than said applied laser energy and said second layer has a second ablation threshold that is greater than said applied laser energy, wherein said laser energy penetrates through said second layer to said first layer; and
generating a void space between said first layer and said second layer to form the channel, which has a major elongate axis and is capable of transferring, receiving and/or storing materials.

2. The method according to claim 1, wherein said applying laser energy to said region comprises forming a first track and a second track distinct from said first track along the surface of the substrate; where said generating further comprises generating a first void space corresponding to said first track and generating a second void space corresponding to said second track, wherein at least a portion of said first void space and said second void space overlap to provide said channel.

3. The method according to claim 1, wherein said first layer comprises silicon (Si(100)).

4. The method according to claim 1, wherein said second layer comprises a material selected from the group consisting of thermally grown oxide (SiO₂) and/or plasma enhanced chemical vapor deposited (PECVD) oxide (SiO₂) films, and mixtures thereof.

5. The method according to claim 1, wherein said first ablation threshold energy is less than about 0.4 J/cm² and said second ablation threshold energy is greater than about 1 J/cm², and a fluence of a pulse of said applied laser energy is less than about 0.8 J/cm².

6. The method according to claim 1, wherein said first layer comprises a first material that absorbs at least about 85% of said applied laser energy and said second layer comprises a second material which permits at least about 80% of said applied laser energy to pass.

7. The method according to claim 1, wherein said channel has a width of greater than or equal to about 100 nm to less than or equal to about 1 mm.

8. The method according to claim 1, wherein said channel has a width of greater than or equal to about 100 nm to less than 20 μm.

9. The method according to claim 1, wherein said channel has a height of greater than or equal to about 10 nm to less than or equal to about 500 μm.

10. The method according to claim 1, wherein said channel has a cross-sectional area that is substantially uniform along the major elongate axis.

11. The method according to claim 1, wherein said laser has a write-speed for forming the channel of greater than about 1 cm/s.

12. The method according to claim 1, wherein a plurality of channels are formed on the substrate surface concurrently by the ultrashort pulsed laser.

13. The method according to claim 1, wherein the laser energy is applied at a non-normal incidence angle to the surface of the substrate.

14. The method of claim 1, wherein said device is microelectronic device selected from a microprocessor, a capacitor, an electrochemical cell.

15. The method according to claim 1, wherein the microfluidic device is a chromatography device, an electrophoretic device, a separation device, a bioassay device and/or a lab-on-a-chip device.

16. The method according to claim 1, wherein said ultrafast laser femtosecond pulsed laser that has a pulse repetition rate frequency of greater than or equal to about 125 Hz, a pulse duration of less than or equal to about 100 picoseconds.

17. A method of forming an electrochemical cell comprising:
applying laser energy generated by an ultrashort pulsed laser to the surface of a substrate comprising at least two layers, wherein at least one of said layers is an active material for the electrochemical cell and at least one of said at least two layers has a first ablation threshold that is less than said applied laser energy and another of said at least two layers has a second ablation threshold that is greater than said applied laser energy, wherein said laser energy penetrates through said layer having said second ablation threshold to said layer having said first ablation threshold; and
generating at least one void space between said at least two layers to form a channel having a major elongate axis, which is capable of containing a second active material.

18. The method of claim 17, wherein said after said generating, said method further comprises applying a third layer over said surface of the substrate and applying a fourth layer over said third layer, wherein said third layer has a third ablation threshold that is less than said applied laser energy and said fourth layer has a fourth ablation threshold that is greater than said applied laser energy; and generating at least one void space between said third and fourth layers to form a second channel having a major elongate axis, which is capable of containing a third active material.

19. The method of claim 17, wherein said layer having said second ablation threshold is a solid state electrolyte for a battery.

20. The method of claim 17, wherein said layer having said first ablation threshold is an electrode for a battery.

21. A method of forming a cooling channel on a surface of a device, the method comprising:
applying laser energy generated by an ultrashort pulsed laser to a region of the surface of the device, wherein said region of the substrate comprises a first layer which is in contact with a distinct second layer, wherein said first layer has a first ablation threshold that is less than said applied laser energy and said second layer has a second ablation threshold that is greater than said applied laser energy, wherein said laser energy penetrates through said second layer to said first layer; and
generating a void space between said first layer and said second layer, thereby forming a fluid channel having a major elongate axis capable of receiving a heat transfer medium for cooling the device.

22. The method of claim 21, wherein the device is a microelectronic device and said first layer comprises silicon and said second layer comprises a material selected from the group consisting of thermally grown oxide (SiO₂) and/or plasma enhanced chemical vapor deposited (PECVD) oxide (SiO₂).
